(19) United States
(12) Patent Application Publication
(10) Pub. No.: US 2021/0005349 A1
(43) Pub. Date: Jan. 7, 2021

(54) HIGH TEMPERATURE-RESISTANT CABLE FOR MOBILE BASE STATION

(71) Applicant: Jiangsu Hengdxin Technology Co., Ltd, WuXi City (CN)

(72) Inventors: YongJian Chen, ChengDu City (CN); ZhaoHong Pan, ChengDu City (CN); YongChi Wang, ChengDu City (CN); ZhiWei Xu, ChengDu City (CN)

(21) Appl. No.: 16/076,121

(22) PCT Filed: Sep. 25, 2017
(86) PCT No.: PCT/CN2017/103105

§ 371 Date: Sep. 22, 2020

(30) Foreign Application Priority Data
May 4, 2017 (CN) 201710311360.7

(51) Int. Cl. H01B 7/295; H01B 7/18; H01B 7/02; H01B 11/18

(52) U.S. Cl. CPC H01B 7/295; H01B 7/185; H01B 11/1834; H01B 11/1895; H01B 7/02

(57) ABSTRACT

Disclosed is a high-temperature resistant cable for a mobile base station which is related to the technical field of mobile base station accessories. The high-temperature resistant cable for a mobile base station of the present disclosure comprises an inner conductor, a PTFE insulation layer, an outer conductor and a sheath successively, wherein the PTFE insulation layer has at least one hollow channel extending in an extending direction of the inner conductor. The plurality of hollow channels are parallel to and symmetrically distributed around the inner conductor.

### CROSS-REFERENCE TO RELATED APPLICATIONS

This application is a national stage filing under 35 U.S.C. § 371 of international application number PCT/CN2017/103105, filed Sep. 25, 2017, which claims priority to Chinese patent application No. 201710311360.7 filed May 4, 2017. The contents of these applications are incorporated herein by reference in their entirety.

### FIELD

The present disclosure relates to the technical field of mobile base station accessories, and more particularly, the present disclosure relates to a high-temperature resistant cable for a mobile base station.

### BACKGROUND

In the field of mobile communications, the miniaturization and large gain of mobile base station antennas are the trend of future development. A conventional high temperature cable, such as a RG141 semi-flexible cable, used in base station antennas has special advantages such as high temperature resistance, low intermodulation, good bending performance, and good mechanical phase stability. However, the RG141 cable is not suitable for large gain antennas due to large attenuation determined by its structure and size. If RG250 is used instead of the RG141 cable, the cost for a coaxial cable used in the antenna is increased by nearly 200%, and the larger size of the RG250 leads to an increase in the bending radius of the cable and is not conducive to the cable arrangement inside the antenna.

Moreover, a combined process of tin-plated copper wire weaving and tin immersing is typically adopted for the outer conductor of the high temperature cables in the prior art, which will crack after being bent for multiple times. As shown in FIG. 1, the strength of the position where a connector bottom of a high temperature cable assembly used in the antenna is welded to the cable is poor, which can easily cause cracking of the outer conductor of the cable when bending. Even if a heat-shrinkable tube is used to increase the strength, it is still difficult to completely solve the problem that the outer conductor is easy to crack.

Therefore, there is an urgent need to develop a high temperature cable with small size, low loss, excellent bending performance, low intermodulation, and high strength to simultaneously meet the requirements for the miniaturization and large gain of mobile base station antennas.

### SUMMARY

In order to solve the above-mentioned technical problem in the prior art, an object of the present disclosure is to provide a high-temperature resistant cable for a mobile base station.

In order to solve the technical problems described in the present disclosure and achieve the object of the present disclosure, the present disclosure adopts the following technical solutions.

A high-temperature resistant cable for a mobile base station comprising an inner conductor, a PTFE insulation layer, an outer conductor and a sheath successively, wherein the PTFE insulating layer has at least one hollow channel extending in an extending direction of the inner conductor.

Wherein the PTFE insulation layer has a plurality of the hollow channels which are not communicated with one another.

Wherein the plurality of hollow channels are parallel to and symmetrically distributed around the inner conductor.

Wherein the inner conductor is a single silver-plated copper wire or a plurality of silver-plated copper stranded wires.

Wherein the outer conductor is a spiral copper tube.

Wherein the PTFE insulation layer has an outer diameter of 2.0 to 20.0 mm, preferably 2.0 to 10.0 mm.

Wherein the hollow channel has a diameter of 0.20 to 5.0 mm, preferably 0.20 to 2.0 mm, more preferably 0.30 to1.50 mm.

Wherein the PTFE insulation layer is formed by extruding and sintering a pasty PTFE material.

Wherein the sheath is made of low smoke zero halogen (LSZH type) or fluorinated ethylene propylene copolymer (FEP) and other high temperature resistant materials.

Compared with the closest prior art, the high-temperature resistant cable for a mobile base station according to the present disclosure has the following advantageous effects.

The high-temperature resistant cable for a mobile base station of the present disclosure has the same size as a conventional semi-flexible cable, but has higher strength, excellent bending performance, and lower intermodulation and loss, and can adapt to the trend of miniaturization and large gain of mobile antenna base stations.

### BRIEF DESCRIPTION OF THE DRAWINGS

FIG. 1 is a photograph showing cracking of an outer connector at a position where a connector of a high temperature cable assembly is welded to the cable in the prior art.

FIG. 2 is a schematic view of an overall structure of a high-temperature resistant cable for a mobile base station according to the present disclosure.

FIG. 3 is a schematic cross-sectional view of the high-temperature resistant cable for a mobile base station according to the present disclosure.

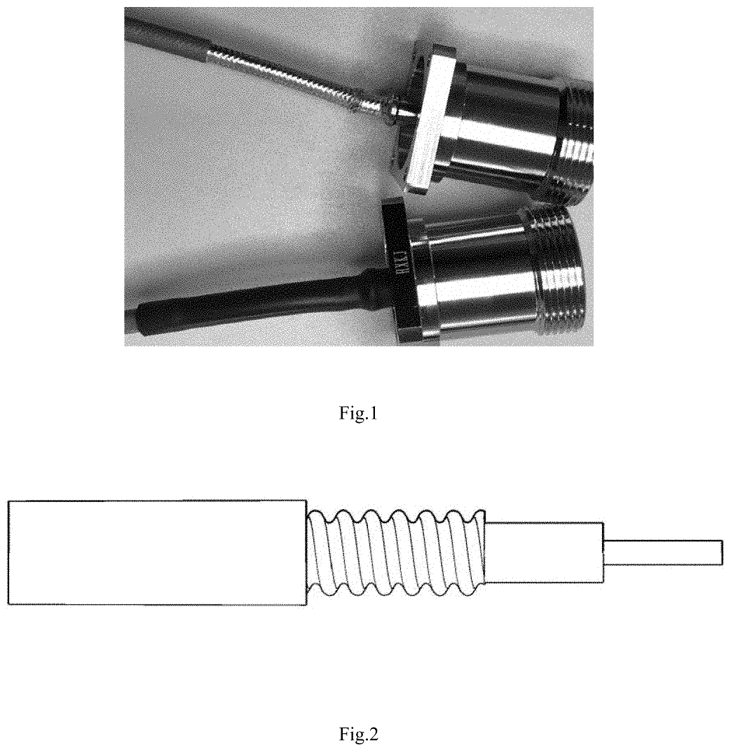

### DETAILED DESCRIPTION OF THE EMBODIMENTS

A high-temperature resistant cable for a mobile base station according to the present disclosure will be further described hereinafter with reference to the specific embodiments, so as to provide a more complete and clear description to the technical solution of the present disclosure.

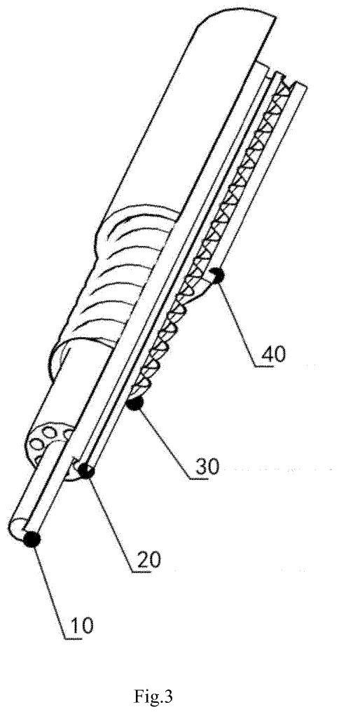

As shown in FIGS. 2 to 3, the high-temperature resistant cable for a mobile base station in this embodiment comprises an inner conductor 10, a PTFE insulation layer 20, an outer conductor 30 and a sheath 40 successively. The PTFE insulating layer has at least one hollow channel extending along an extending direction of the inner conductor. The plurality of hollow channels are parallel to the inner conductor, and the plurality of hollow channels are symmetrically distributed around the inner conductor.

In the present disclosure, in order to meet the requirement of high-frequency transmission characteristics, the inner conductor is preferably made of a silver-plated copper wire. For example, a single silver-plated copper wire or a plurality of silver-plated copper wires can be selected. As a noble metal, the silver is used as a plated layer for the conductive wire core, which can reduce the loss of the conductor under high-frequency radio frequency conditions, and is advantageous to improve or guarantee the performance of the cable under high temperature and high frequency conditions, and the silver plated layer can also provide good thermal conductivity and thermal oxidation resistance, which is conducive to forming the PTFE insulation layer on the inner conductor through extrusion and sintering processes.

Different from the swelling microporous polytetrafluorethylene insulating layer typically adopted in the prior art, the PTFE insulation layer having at least one hollow channel extending along the extending direction of the inner conductor is adopted in the present disclosure. The PTFE insulating layer has an outer diameter of 2.0 to 20.0 mm, and preferably 2.0 to 10.0 mm. The hollow channel has a diameter of 0.20 to 5.0 mm, preferably 0.20 to 2.0 mm, and more preferably 0.30 to 1.50 mm. The PTFE insulation layer having the hollow channel not only guarantees the temperature resistant level of the PTFE insulation layer, but also can reduce the dielectric constant of the PTFE insulation layer since air is filled in the hollow channel; and the PTFE insulation layer has a lower dielectric loss, which is suitable for the high frequency and ultra high frequency working environments to which the present disclosure are applied. At the same time, compared with an ordinary swelling microporous polytetrafluoroethylene insulation layer, the use of the insulation layer having a hollow channel can also reduce the amount of PTFE materials, and improve the utilization of the PTFE materials, for example, under the premise of guaranteeing the strength and temperature resistance of the insulation layer, it is usually possible to reduce the amount of the PTFE materials by 10% to 50% depending on the diameter of the hollow channel and the number of the hollow channel. The PTFE insulation layer is formed by extruding and sintering a pasty PTFE material.

Specifically, the insulation layer having a hollow channel according to the present disclosure is obtained by extruding, drying, and sintering the pasty PTFE material using an extruder. The extruder includes a die head and a die core, and the die head has a conically tapering portion and a die hole communicated with a bottom of the conically tapering portion; the die core has a central hole for conveying the inner conductor, and a plurality of rods extending in a direction parallel to an axis of the die core are disposed symmetrically around the central hole. The rods are disposed in the die hole for forming the hollow channels. Specifically, the process is as follows: the pasty PTFE material is extruded through the conically tapering portion of the die head and extruded out of an outlet of the die hole to form a PTFE insulation layer blank surrounding the inner conductor, and the extruded PTFE insulation layer blank can be dried at a temperature of 100 to 250° C., so that lubricating oil in the PTFE insulation layer blank is volatilized and removed. When the drying process is performed, hot air flow can be introduced to accelerate the volatilization of the lubricating oil, then the dried PTFE insulation layer blank is sintered and solidified in a curing furnace, and a temperature for sintering and solidifying can be, for example, higher than a PTFE melting temperature and lower than 500° C., for example, preferably from 400 to 480° C., to obtain the PTFE insulation layer of the present disclosure. In the present disclosure, the pasty PTFE material is usually configured by using PTFE, lubricating oil, or the like, or a commercially available pasty PTFE material may also be used, for example, a pasty material named Fluon CD4 (Imperial Chemical Industries) may be used. Fluorine atoms in a PTFE molecular chain are symmetrically and evenly distributed without inherent dipole moment, making a dissipation factor tgδ and relative dielectric constant thereof change slightly within a range from low frequency to high frequency, and tgδ is also almost constant in the temperature range from room temperature to its operating temperature and even up to 300° C., and theoretically, the tgδ value is theoretically about 0.0001. However, in the present disclosure, the pasty PTFE material is used. Since the lubricant therein is difficult to volatilize completely and sintered, the dielectric loss tgδ is typically 0.00035 to 0.00050. However, the applicant has found that adding a small amount of nano-copper oxide, especially 0.05 to 0.5wt % (preferably 0.05 to 0.30) of the pasty PTFE material, to the pasty PTFE material helps to reduce the dissipation factor tgδ, but does not affect the bending performance, and has little effect on the dielectric constant, this may result from the improved sintering performance of the PTFE insulation layer blank by the nano-copper oxide and reduction of crystallization loss. Table 1 below shows the influence of the content of the nano-copper oxide on the dielectric loss tgδ (resonant cavity method).

TABLE 1

| | | | | | | | | | | | |
|---|---|---|---|---|---|---|---|---|---|---|---|
| Content | 0 | 0.01 | 0.02 | 0.03 | 0.05 | 0.10 | 0.20 | 0.30 | 0.40 | 0.50 | 0.60 |
| tgδ | 0.00045 | 0.00042 | 0.00045 | 0.0041 | 0.00035 | 0.00030 | 0.0025 | 0.0028 | 0.00035 | 0.00040 | 0.0010 |

In the present disclosure, the outer conductor is a spiral copper tube. The structural strength of the outer conductor and the bending performance of the outer conductor are further improved by using the spiral copper tube instead of the outer conductor fabricated by a combined process of wire weaving and tin immersing. Moreover, a double-channel of air medium formed by air medium between the spiral copper tube and the PTFE insulation layer and air medium inside the hollow channels of the PTFE insulation layer further reduces the insulation dielectric constant, which is beneficial for further reducing the dielectric loss. In the present disclosure, the outer conductor is formed of a copper tape through conventional machining, welding, stretching, sizing, and embossing processes. In order to reduce the loss and improve the bending performance, the pitch, peak, and trough between the screw threads should be consistent to the greatest extent. The copper tape should be larger than 0.15 mm and a surface thereof should be smooth, clean, and free from defects such as peeling, burrs, inclusions, and the like.

In the present disclosure, the sheath is disposed on an outermost layer for protecting the inner conductor, the outer conductor, and the PTFE insulation layer inside. The sheath may be made of materials such as low smoke zero halogen (LSZH type) or fluorinated ethylene propylene copolymer (FEP) with low smoke, low toxicity, low corrosion and high flame retardant property, which not only can provide the cable with good mechanical and flame retardant properties, but also are safe and environmentally friendly.

### First Embodiment

The high-temperature resistant cable in this embodiment comprises a silver-plated copper wire inner conductor, a PTFE insulation layer having seven hollow channels parallel to an extension direction of the inner conductor and symmetrically formed around the inner conductor, a spiral copper tube and a LSZH flame retardant polyolefine. The silver-plated copper wire inner conductor has a diameter of 1.15±0.02 mm, and the silver-plated layer has a thickness greater than 1 μm. The PTFE insulation layer has an outer diameter of 3.00±0.05 mm. There are seven hollow channels symmetrically distributed, each having a diameter of 0.3 to 0.5 mm. The spiral copper tube has an outer diameter of 4.25±0.10 mm. The sheath has an outer diameter of 5.20±0.10 mm.

### Second Embodiment

The high-temperature resistant cable in this embodiment comprises a silver-plated copper wire inner conductor, a PTFE insulation layer having seven hollow channels parallel to an extension direction of the inner conductor and symmetrically formed around the inner conductor, a spiral copper tube and a fluorinated ethylene propylene copolymer FEP. The silver-plated copper wire inner conductor has a diameter of 1.15±0.02 mm, and the silver-plated layer has a thickness greater than 1 μm. The PTFE insulation layer has an outer diameter of 3.00±0.05 mm. There are seven hollow channels symmetrically distributed, each having a diameter of 0.3 to 0.5 mm. The spiral copper tube has an outer diameter of 4.25±0.10 mm. The sheath has an outer diameter of 5.00±0.10 mm.

According to a coaxial cable signal transmission principle, the transmission attenuation of the cable is mainly generated by the heat generation of the inner conductor, the insulation, and the outer conductor. The present disclosure improves the structure and material of the cable, which not only solves the mechanical property problems of the cable like bending cracking and insufficient strength, but also significantly reduces the overall attenuation of the cable due to a significant reduction in overall dielectric constant and loss.

For a person of ordinary skill in the art, the specific embodiments are merely intended to describe the present disclosure in an exemplary manner, and it is obvious that the specific implementation of the present disclosure is not limited by the above manner. Any non-substantive improvements made by using the method concepts and technical solutions of the present disclosure, or applying the concept and technical solutions of the present disclosure directly to other occasions without improvements shall all fall within the protection scope of the present disclosure.

1. A high-temperature resistant cable for a mobile base station comprising an inner conductor, a PTFE insulation layer, an outer conductor and a sheath successively, wherein the PTFE insulating layer has at least one hollow channel extending in an extending direction of the inner conductor.

2. The high-temperature resistant cable for a mobile base station according to claim 1, wherein the PTFE insulating layer has a plurality of the hollow channels which are not communicated with one another.

3. The high-temperature resistant cable for a mobile base station according to claim 2, wherein the plurality of hollow channels are parallel to and symmetrically distributed around the inner conductor.

3. (canceled)

4. The high-temperature resistant cable for a mobile base station according to claim 1, wherein the outer conductor is a spiral copper tube.

5. The high-temperature resistant cable for a mobile base station according to claim 1, wherein the PTFE insulation layer has an outer diameter of 2.0 to 20.0 mm.

6. The high-temperature resistant cable for a mobile base station according to claim 5, wherein the PTFE insulation layer has an outer diameter of 3.0 to 20.0 mm.

7. The high-temperature resistant cable for a mobile base station according to claim 5, wherein the hollow channel has a diameter of 0.20 to 5.0 mm.

8. The high-temperature resistant cable for a mobile base station according to claim 7, wherein the hollow channel has a diameter of 0.20 to 2.0 mm.

9. The high-temperature resistant cable for a mobile base station according to claim 1, wherein the PTFE insulation layer is formed by extruding and sintering a pasty PTFE material.

10. The high-temperature resistant cable for a mobile base station according to claim 1, wherein the sheath is made of low smoke zero halogen or fluorinated ethylene propylene copolymer and other high temperature resistant materials.

11. The high-temperature resistant cable for a mobile base station according to claim 1, wherein the inner conductor is a single silver-plated copper wire or a copper stranded wire with a plurality of silver-plated copper wires.
